(19) United States
(12) Patent Application Publication
(10) Pub. No.: US 2012/0191305 A1
(43) Pub. Date: Jul. 26, 2012

(54) CLOSING DEVICE OF A MOTOR VEHICLE AND METHOD OF OPERATING THE SAME

(75) Inventors: Zoltan Ersek, Stuttgart (DE); Gabriel Wetzel, Korntal-Muenchingen (DE); Kenneth Lawrence Garvey, Stuttgart (DE)

(73) Assignee: ROBERT BOSCH GMBH, Stuttgart (DE)

(21) Appl. No.: 13/382,944

(22) PCT Filed: Jul. 2, 2010
(86) PCT No.: PCT/EP10/59424

§ 371 Date: Apr. 17, 2012

(30) Foreign Application Priority Data
Jul. 9, 2009 (DE) 102009027597.5

(51) Int. Cl. G06F 7/00

(52) U.S. Cl. 701/49

(57) ABSTRACT

The invention relates to a method for operating a closing device (1) in a motor vehicle for detecting a pinching case, wherein an object is pinched between a moving closing element (2) of the closing device and a stop edge (3) of the closing device (1) during a closing operation, having the following steps: determining (S2) an indicator of the instantaneous closing force during a closing operation; determining (S4) an indicator of a force of acceleration indicating a force of acceleration acting on the closing element (2) of the closing device (1) during a closing operation; providing (S5) a closing force threshold value depending on the indicator of the force of acceleration; detecting (S6) a pinch case if the determined indicator of the instantaneous closing force exceeds the closing force threshold value.

### BACKGROUND OF THE INVENTION

The invention relates to a closing device of a motor vehicle, in particular an electrically actuable window lifter, an electrically actuable sliding roof and the like, and furthermore to a method for operating a closing device of this type.

In the case of closing devices on the motor vehicle, such as, for example, electric window lifters, electric sliding roofs and the like, it has to be ensured that, during a closing operation, no objects or body parts which may be damaged or injured are located between a closing element (window pane, sliding roof) and a stop edge (window frame, roof recess). In order to avoid such a situation, an algorithm is implemented in a control unit, which activates a servomotor coupled to the closing element, the algorithm detecting such a case of trapping and interrupting the closing operation or undertaking a reversing thereof, in which the closing element at least temporarily executes an opening movement.

In order to detect a case of trapping, the position of the closing element and the closing force which has to act on the closing element in order to carry out the closing operation have to be continuously checked and, if there is a reduction in the velocity of the closing movement and/or if there is an increase of the closing force required for maintaining the closing movement, it is concluded that there is a case of trapping.

In the realization of trapping detection, it has to be ensured that it is established if there is an increase of force during the closing operation which can be attributed to trapping. In this case, there has to be an immediate response and the closing element has to be opened again in an opening movement (reversing). An erroneous determination in the detection of a case of trapping by the algorithm can lead to permanent trapping of an object or of a body part or—in the case of detection of an error—can cause a defective reversing of the closing element, thus impairing the comfort.

A frequent solution for detecting a reduction in the velocity of the closing movement is based on an evaluation of the rotational speed profile of the servomotor. For example, the servomotor can have a ring magnet and a Hall sensor for this purpose. As a result, the rotational speed of the motor can simply be detected by evaluating square wave signals which are produced by the ring magnet running past the Hall sensor. The frequency of the square wave signals, constitutes an indication of the rotational speed. A change in the rotational speed can be established from the signals detected in this manner. In the event of a rapid drop in the rotational speed which does not occur until an end position, it can be concluded that there is an increased closing force and, therefore, a resistance. A further method determines the rotational speed of the servomotor with the aid of an evaluation of the motor current. Said current has ripples corresponding to the revolution of the armature of the servomotor.

As a rule, the algorithm makes provision for the case of trapping to be identified when the closing force or a corresponding indication exceeds a predetermined closing force threshold value.

If a vehicle having a closing device of this type travels along an uneven carriageway, the required force necessary for carrying out the closing movement of the closing part also varies. Depending in each case on the tolerance with which the closing force threshold value is determined with respect to the normally required closing force, in a closing operation of the closing device during simultaneous travel along an uneven carriageway an erroneous detection of a case of trapping may occur, and therefore the driver has to undertake several attempts, by actuating a corresponding operating element, to close the closing device. Since, owing to safety aspects, the tolerance for a closing force threshold value of this type is, as a rule, frequently set to be very low, a trapping event is frequently erroneously detected during a closing operation of the closing device in particular when driving on an uneven carriageway.

It is therefore the object of the present invention to provide reliable detection of a trapping event during a closing operation of a closing part of a closing device in a motor vehicle, wherein, in particular, the risk of erroneous detection of a closing operation is reduced.

### SUMMARY OF THE INVENTION

According to a first aspect, a method for operating a closing device in a motor vehicle and for detecting a case of trapping is provided, in which, during a closing operation, an object is trapped between a moving closing element of the closing device and a stop edge of the closing device. The method comprises the following steps:

determining an indication of the closing force at a particular instant during a closing operation;

determining an acceleration force indication which indicates an acceleration force acting on the closing element of the closing device during a closing operation;

providing a closing force threshold value depending on the acceleration force indication;

detecting a trapping case when the determined indication of the closing force at a particular instant exceeds the closing force threshold value.

One concept of the invention consists in detecting when the closing element of the closing device is subjected to external acceleration forces, for example owing to the vehicle driving over an uneven carriageway, and, as a result, the detecting of a case of trapping during a closing movement of the closing element is impaired. In particular when acceleration forces of this type occur, in order to avoid a trapping event being erroneously detected, a closing force threshold value for an indication of the closing force is varied, in particular increased, for example when such acceleration forces occur.

Furthermore, a change in the movement velocity of the closing element or a closing force to be used for the closing operation can be determined as the indication of the closing force at a particular instant during a closing operation.

According to one embodiment, an indication of the acceleration force acting on the closing element at a particular instant is determined as the acceleration force indication.

As an alternative, an indication of the quietness of driving of the motor vehicle can be determined as the acceleration force indication. In particular, the acceleration force indication can indicate an indication of a maximum or average amplitude of varying acceleration forces, in particular acceleration forces having an alternating sign. Furthermore, the acceleration force indication can be indicated with the aid of a signal provided externally, such as, for example, information regarding the road condition from a driving dynamics braking system or the like.

The closing force threshold value can be varied in accordance with a continuous function depending on the acceleration force indication.

According to one embodiment, the closing force threshold value can be increased when the acceleration force indication exceeds a threshold value, wherein, in particular, the closing force threshold value is increased by an absolute amount or relatively.

In order to take position-dependent, frictionally induced differences into consideration in the closing force to be used, the closing force threshold value can furthermore be determined depending on a position of the closing element with respect to the stop edge.

According to a further aspect, a closing device for a motor vehicle is provided. The closing device comprises:

a closing element which is movable toward a stop edge;

a servomotor for moving the closing element in the direction of the stop edge;

a control unit which is designed

in order to determine an indication of the closing force at a particular instant during a closing operation;

to determine an acceleration force indication which indicates an acceleration force acting on the closing element during a closing operation;

providing a closing force threshold value depending on the acceleration force indication;

detecting a case of trapping, in which, during the closing operation, an object is trapped between the moving closing element and the stop edge, when the determined indication of the closing force at a particular instant exceeds the closing force threshold value.

### BRIEF DESCRIPTION OF THE DRAWINGS

Preferred embodiments are explained in more detail below with reference to the attached drawings, in which:

FIG. 1 shows a schematic illustration of a window lifting system with an electric window lifter and a control unit; and

FIG. 2 shows a flow diagram for illustrating a method for operating the closing device.

### DETAILED DESCRIPTION

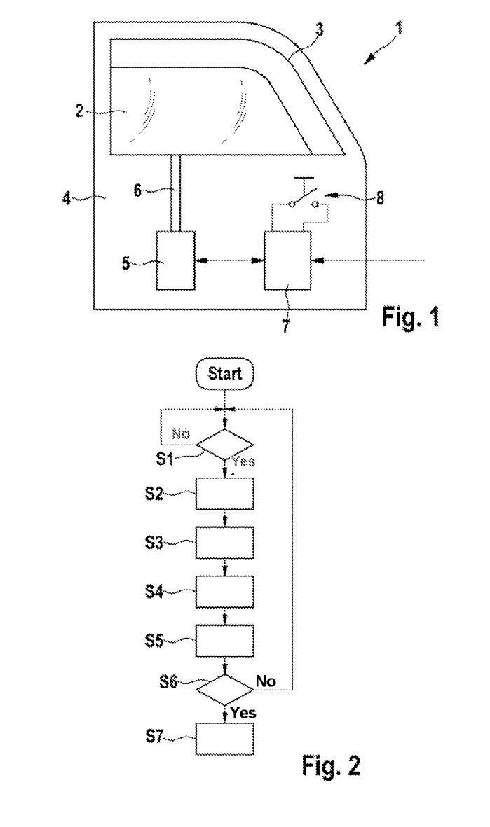

As an example of a closing device, FIG. 1 shows a window lifting system 1 for a motor vehicle, in which a window pane 2 (closing element) can be moved up and down within a window frame 3 in a vehicle door 4, in order to close and to open the window. The movement of the window pane 2 is undertaken by a servomotor 5 which is coupled to the window pane 2 via a suitable mechanism 6. For example, the mechanism 6 can be designed in such a manner that the window pane 2 is moved up and down depending on the rotational movement of the servomotor 5. For this purpose, the mechanism 6 may comprise a corresponding gearing, for example a worm gearing, in order to convert a rotational movement into a translational movement of the window pane 2.

The servomotor 5 is activated by a corresponding activating variable via a control unit 7, for example by application of an activating voltage or an activating signal depending on an actuating state of a switch 8. The switch 8 is coupled to the control unit 7 and can be actuated by a user of the vehicle in order to move the window pane 2 up and down so as to close and to open the window. The control unit 7 furthermore receives one or more operating variables from the servomotor 5, from which operating variables an operating state of the servomotor 5 and of the window lifter can be determined.

For example, a motor current or a rotational speed of the servomotor 5 can be determined as operating variables. The rotational speed of the servomotor can constitute an indication of the closing force when the window pane 2 is moved upward in the closing direction. Similarly, the level of the motor current can be an indication of the controlling torque provided with the servomotor, and thus can likewise be an indication of the closing force. Furthermore, a rotational speed of the servomotor 5 can be determined via ripples in the motor current, and therefore, correspondingly, during the above determination of the rotational speed, an indication of the rotational speed can be determined as an indication of the closing force. In the control unit 7, the indication of the closing force at a particular instant can be compared with a closing force threshold value, wherein, when the closing force threshold value is exceeded by the size of the closing force indication, it can be concluded that there is a case of trapping and, correspondingly, the servomotor 5 is stopped and/or reversed in the control unit 7.

The changeover is frequently non-linear in the mechanism 6, and therefore, in different window positions (opening positions) of the window pane 2, different closing forces are necessary in order to carry out a closing movement of the window pane 2. It may therefore be expedient, furthermore, to obtain a position of the window pane 2 or an absolute position of the servomotor 5 as the operating variable, in order thus to provide a variable closing force threshold value depending on the window position. The assignment between the window position (position of the closing element) and of the closing force threshold value can be realized, for example, by a corresponding characteristic map in the control unit 7. It is thereby ensured that firstly, in a sluggish position range of the window pane 2 (caused, for example, by the changeover in a gearing of the mechanism 6) the closing force threshold value is set at such a high level that no case of trapping is detected. Secondly, in a smooth-running position range of the window pane 2, the closing force threshold value is correspondingly reduced in order to continue to ensure that a case of trapping is detected even at a slight increase of the closing force.

The closing force for carrying out a closing movement of the window pane 2 is determined by the weight of the window pane 2, the friction losses of the window pane in the window frame 3, the friction losses in the mechanism 6, in particular in the gearing, the friction losses in the servomotor 5 and the acceleration force of the starting phase of the servomotor 5 at the beginning of the closing operation of the window pane 2. In particular, the friction forces can be position-dependent, and therefore, in the event of a variable closing force threshold value dependent on the position of the window pane 2, a corresponding position dependency can be predetermined.

However, the required closing force for carrying out a closing movement of the window pane 2 is furthermore influenced by translational acceleration movements of the entire closing device, i.e. of the vehicle door or the vehicle window 2, as can be caused, for example, when the vehicle drives along an uneven carriageway. Acceleration forces in the closing or opening direction of the window pane 2 thus act directly on the closing force to be used in a closing operation, and acceleration forces which act transversely with respect to the closing or opening direction indirectly influence the friction of the window pane 2 in the window frame. If the motor vehicle then drives over an uneven carriageway, irregular acceleration forces are exerted on the window pane 2, leading to an increase in the required closing force. As a result, under some circumstances, the closing force threshold value may be exceeded when the electric window lifter is actuated to close the window, and therefore a case of trapping is erroneously detected.

In order to avoid this, provision is now made to provide an indication of the acceleration forces acting on the window pane. In the simplest case, this can be undertaken with the aid of an acceleration meter which is arranged in the vicinity of the window lifting device (closing device). As an alternative, the control unit 7 can be provided with information regarding the road condition, the information being known, for example, from driving dynamics (braking) systems. The locking of the wheels is intended to be differentiated therein from wheel rotation which is not constant due to an uneven carriageway or a poor carriageway covering.

FIG. 2 shows a flow diagram for illustrating a method for operating an electric window lifter. It is asked in step S1 whether the switch 8 has been actuated, which is used by the motor vehicle driver to indicate that the window is intended to be closed by moving of the window pane 2 upward. If this is not the case (alternative: no), a jump is made back to step S1. If this the case (alternative: yes), then, in a step S2, an indication of the closing force at a particular instant, which has to be used in order to carry out the closing operation, is determined. For this purpose, the servomotor 5 retrieves operating variables, for example the motor current or indications of the rotational speed at a particular instant, which can each constitute an indication of the closing force used.

In a subsequent step S3, a closing force threshold value is determined, in particular depending on a position of the servomotor or of the window pane 2 at a particular instant.

In a step S4, acceleration information which constitutes an indication of the acceleration forces acting on the window pane 2 is provided. Said acceleration information can either indicate an acceleration force acting at a particular instant or an average amplitude of the fluctuating (oscillating) acceleration forces acting on the window pane 2, as may occur, for example, in a positive and negative direction during driving of the vehicle along an uneven or poor carriageway.

In a step S5, the closing force threshold value is modified depending on the acceleration information determined in step S4. For example, the closing force threshold value can be increased by a certain amount as soon as the acceleration force at a particular instant or an average value of the amounts of fluctuating acceleration forces acting on the window pane 2 exceed a certain amount.

As an alternative or in addition, the closing force threshold value may also be varied in accordance with a continuous function directly dependant on the level of the acceleration which is indicated by the acceleration information and acts on the window pane 2. In particular, the acceleration information can be information concerning whether the vehicle is travelling over an uneven or poor carriageway. In this case, the closing force threshold value can be acted upon with a factor>1 or with an absolute tolerance amount in order, in this case, to increase the tolerance range, in which the required closing force does not lead to detection of a case of trapping.

In a step S6, the closing force at a particular instant is compared with the closing force threshold value. When the closing force threshold value is exceeded by the indication of the closing force, a case of trapping is indicated (alternative: yes) and, if the closing force threshold value is not exceeded, a jump is made back to step S1. If exceeding of the closing force threshold value is detected (alternative: yes) the servomotor 5 can be stopped or reversed in order to release the trapped object or the trapped body part again.

1. A method for operating a closing device in a motor vehicle and for detecting a case of trapping, in which, during a closing operation, an object is trapped between a moving closing element of the closing device and a stop edge of the closing device, the method comprising:
determining an indication of the closing force at a particular instant during a closing operation;
determining an acceleration force indication which indicates an acceleration force acting on the closing element of the closing device during a closing operation;
providing a closing force threshold value depending on the acceleration force indication;
detecting a trapping case when the determined indication of the closing force at a particular instant exceeds the closing force threshold value.

2. The method according to claim 1, wherein a change in the movement velocity of the closing element or a closing force to be used for the closing operation is determined as the indication of the closing force at a particular instant during a closing operation.

3. The method according to claim 1, wherein an indication of an acceleration force acting on the closing element at a particular instant is determined as the acceleration force indication.

4. The method according to claim 1, wherein an indication of the quietness of driving of the motor vehicle is determined as the acceleration force indication.

5. The method according to claim 4, wherein the acceleration force indication indicates an indication of a maximum or average amplitude of varying acceleration forces, in particular acceleration forces having an alternating sign.

6. The method according to claim 1, wherein the closing force threshold value is varied in accordance with a continuous function depending on the acceleration force indication.

7. The method according to claim 1, wherein the closing force threshold value is increased when the acceleration force indication exceeds a threshold value.

8. The method according to claim 7, wherein the closing force threshold value is increased by an absolute amount or relatively.

9. The method according to claim 1, wherein the closing force threshold value is furthermore determined depending on a position of the closing element with respect to the stop edge.

10. A closing device for a motor vehicle, the closing device comprising:
a closing element which is movable toward a stop edge;
a servomotor for moving the closing element in the direction of the stop edge;
a control unit which is designed in order to determine an indication of the closing force at a particular instant during a closing operation;
to determine an acceleration force indication which indicates an acceleration force acting on the closing element during a closing operation;
providing a closing force threshold value depending on the acceleration force indication;
detecting a case of trapping, in which, during the closing operation, an object is trapped between the moving closing element and the stop edge, when the determined indication of the closing force at a particular instant exceeds the closing force threshold value.

11. The method according to claim 2, wherein an indication of an acceleration force acting on the closing element at a particular instant is determined as the acceleration force indication.

12. The method according to claim 2, wherein an indication of the quietness of driving of the motor vehicle is determined as the acceleration force indication.

13. The method according to claim 2, wherein the closing force threshold value is varied in accordance with a continuous function depending on the acceleration force indication.

14. The method according to claim 2, wherein the closing force threshold value is increased when the acceleration force indication exceeds a threshold value.
